(19) United States
(12) Patent Application Publication
(10) Pub. No.: US 2026/0203555 A1
(43) Pub. Date: Jul. 16, 2026

(54) ANNOTATION-EFFICIENT MODEL SELECTION FOR ARTIFICIAL INTELLIGENCE TASKS

(71) Applicant: International Business Machines Corporation, Armonk, NY (US)

(72) Inventors: Ariel Gera, Tel Aviv (IL); Benjamin Sznajder, Jerusalem (IL); Shir Ashury Tahan, Jerusalem (IL); LESHEM CHOSHEN, Cambridge, MA (US); Liat EIN-DOR, Tel Aviv (IL); Eyal Shnarch, Kibbutz Gat (IL)

(21) Appl. No.: 19/016,450

(22) Filed: Jan. 10, 2025

(51) Int. Cl. G06N 3/0455

(52) U.S. Cl. CPC G06N 3/0455

(57) ABSTRACT

Mechanisms are provided for selecting and annotating test examples for artificial intelligence (AI) model selection. First and second AI computer models process a test example of a test set to generate a corresponding first AI computer model output and second AI computer model output. A corresponding first vector embedding and second vector embedding are generated and a difference vector is generated based on a difference between the first vector embedding and the second vector embedding. The difference vectors are clustered into a plurality of clusters of difference vectors for test examples of the test set. Representative difference vectors are selected from each cluster and their corresponding test examples are annotated by an oracle for use in selecting an AI model for a task.

### STATEMENT REGARDING PRIOR DISCLOSURES BY THE INVENTOR OR A JOINT INVENTOR

The following disclosure(s) are submitted under 35 U.S.C. 102 (b)(1)(A): DISCLOSURE(S): “Label-Efficient Model Selection for Text Generation”, Shir Ashury-Tahan, Benjamin Sznajder, Leshem Choshen, Liat Ein-Dor, Eyal Shnarch, Ariel Gera, arXiv: 2402.07891v1 [cs.CL], Feb. 12, 2024, 18 pages and in the Proceedings of the 62nd Annual Meeting of the Association for Computational Linguistics (Volume 1: Long Papers), Aug. 11-16, 2024, 19 pages.

### BACKGROUND

The present application relates generally to a data processing apparatus and method and more specifically to a computing tool and computing tool operations/functionality for performing annotation-efficient model selection for artificial intelligence tasks.

The use of artificial intelligence (AI) models for the performance of various tasks in modern computing systems is increasing at a rapid pace. With the advent of language models (LMs) and large language models (LLMs), this is even more the case. However, not all AI models operate well for all tasks.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises processing, by a first artificial intelligence (AI) computer model, each test example of a test set to generate a corresponding first AI computer model output. The method also comprises processing, by a second AI computer model, each test example of the test set to generate a corresponding second AI computer model output. Moreover, the method comprises generating a first vector embedding of the first AI computer model output and a second vector embedding of the second AI computer model output, and generating a difference vector based on a difference between the first vector embedding and the second vector embedding. The method further comprises clustering the difference vectors into a plurality of clusters of difference vectors for test examples of the test set, and selecting, from each cluster in the plurality of clusters, a representative difference vector to generate a plurality of selected representative difference vectors. In addition, the method comprises, for each selected representative difference vector in the plurality of selected representative different vectors, annotating a test example corresponding to the selected representative difference vector with an AI model preference annotation to thereby generate an annotated test example set.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a minimal annotation artificial intelligence (AI) model selection engine in accordance with one illustrative embodiment;

FIG. 3 is an example block diagram illustrating an operational flow of the minimal annotation AI model selection engine in accordance with one illustrative embodiment;

FIG. 4 is an example diagram illustrating an example iterative algorithm for selecting test examples in accordance with one illustrative embodiment; and

FIG. 5 is a flowchart outlining an example operation of a minimal annotation AI model selection engine in accordance with one illustrative embodiment.

### DETAILED DESCRIPTION

The illustrative embodiments provide an improved computing tool and improved computing tool operations/functionality for performing annotation-efficient model selection for artificial intelligence tasks. Artificial intelligence (AI) computer models are fast becoming the primary tool for performance of many automated decision making tasks in various industries. There are a large number of different AI technologies available as well as a large number of trained AI models that may be used to perform these various tasks. However, not all AI models provide similar performance for the same task. That is, some AI models perform better than others depending on the particular task to which they are applied. This may be due to the AI model itself, the training of the AI model, or any of a number of other reasons.

Thus, it is important to properly select the right AI model for a particular task if one is to obtain a satisfactory decision making result from the AI model selected. Such selection of the AI model for a particular task naturally requires some mechanism for comparing AI models and their performance relative to one another. Such comparisons may require the consulting of an “oracle”, i.e., an entity that can judge the AI model outputs and determine a preference between the AI models based on these outputs. The oracle may be a human annotator or it may be an automated computing system, such as a Large Language Model (LLM) based evaluator, or the like, which performs an evaluation of the output and annotates the examples used to evaluate the AI models with the oracle's assessment of the AI model's output.

Implementation of an oracle can be expensive in terms of annotation budgets and computational requirements. For example, with regard to text generation tasks, the oracle is burdened with making nuanced judgements of the quality of generated texts. Often, this can only be done by expert human annotators or very powerful LLMs, both of which are costly to apply at scale. However, these mechanisms require large amounts of annotated inputs/outputs to be able to accomplish the task of selecting between AI models requiring large amounts of time and resources to provide these annotated inputs/outputs. Moreover, as the number of AI models and tasks increases, conducting these evaluations becomes prohibitively expensive.

The illustrative embodiments are directed to providing a solution to issues regarding how to select between a plurality of AI computer models or systems by determining which is better for a given task using a minimal number of annotated examples. The illustrative embodiments addresses these issues of annotation of examples to facilitate selection between AI computer models for tasks by providing a computing tool and computing tool operations/functionality directed to selecting a small number of examples that should be annotated, while still representing the comparative performance between the AI computer models. The mechanisms of the illustrative embodiments allow for selection of AI computer models based on a relatively small set of annotated examples while achieving performance comparable to situations where a full annotation of a full set of examples for a task is utilized.

The mechanisms of the illustrative embodiments rely on the AI computer model outputs to drive the selection of the examples for annotation. Specifically, assuming a pairwise comparison between two AI computer models, the mechanisms of the illustrative embodiments perform inferences on all examples using both AI computer models and then embed each output using a third AI computer model. For example, if the two AI computer models are AI models that generate text output, the third AI computer model may be an encoder language model (LM) that embeds the output. The mechanisms of the illustrative embodiments generate difference vectors, which represent each example in the test dataset, by computing a point-wise difference between the embeddings of the two AI computer model outputs. These difference vectors are then clustered, and a representative example is selected from each cluster.

The mechanisms of the illustrative embodiments are model-agnostic, meaning they can be applied to any AI computer model for selecting between AI computer models, prompts, or configurations. The mechanisms can be used in both scenarios where a maximum number of examples is allowed, or in scenarios where a confidence threshold is used in an iterative approach.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a minimal annotation based AI model section capability so as to identify which AI model will provide the best results for a specific task. It should be appreciated that the illustrative embodiments seek to minimize the annotated examples needed to make this selection. The improved computing tool implements mechanism and functionality, such as the minimal annotation AI model selection engine, which cannot be practically performed by human beings either outside of, or with the assistance of, a technical environment, such as a mental process or the like. The improved computing tool provides a practical application of the methodology at least in that the improved computing tool is able to minimize the amount of annotated examples needed to evaluate the performance of AI models for a given task and select a best performing AI model.

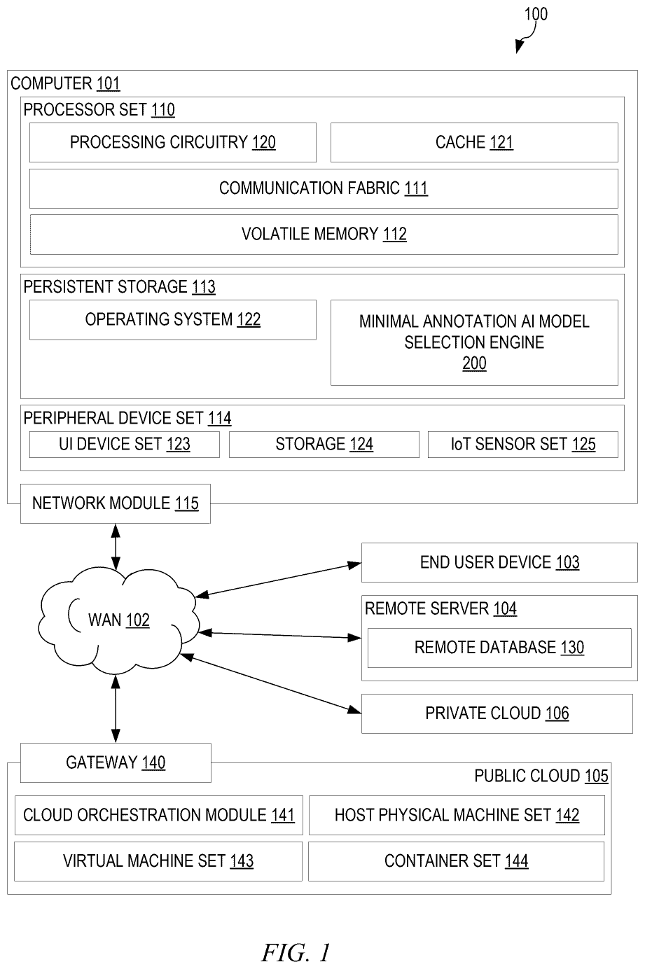

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as minimal annotation AI model selection engine 200. In addition to minimal annotation AI model selection engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and minimal annotation AI model selection engine 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in minimal annotation AI model selection engine 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in minimal annotation AI model selection engine 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a minimal annotation AI model selection engine 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates minimal annotation based AI model selection.

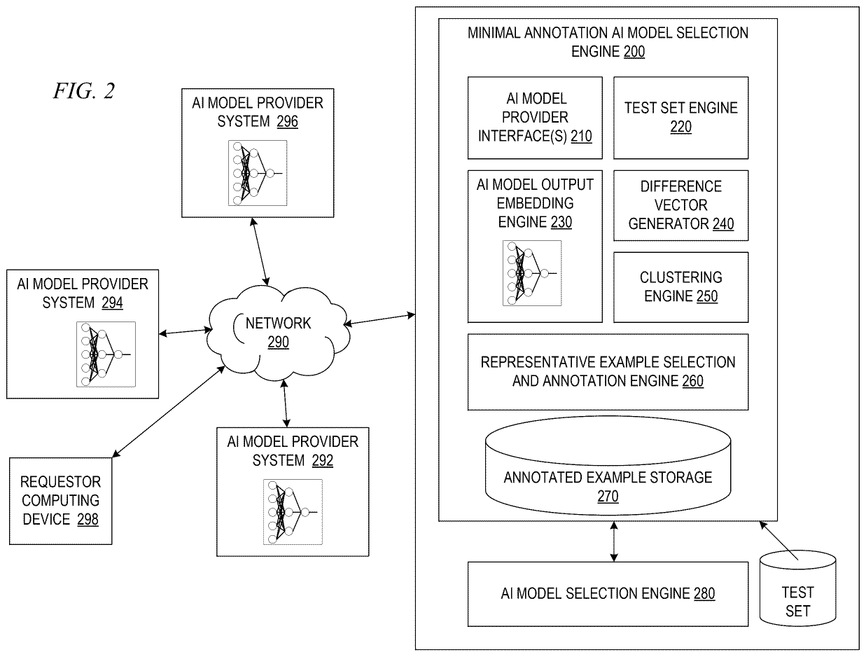

FIG. 2 is an example block diagram illustrating the primary operational components of a minimal annotation AI model selection engine in accordance with one illustrative embodiment. The operational components shown in FIG. 1 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that AI model performance is evaluated for selection of an AI model for a given task, and providing a specific solution that implements a language model (LM) based embedding and clustering mechanism for selecting examples for annotation and use in selecting an AI model, which cannot be practically performed by human beings as a mental process and is not directed to organizing any human activity.

As mentioned above, AI model selection for a given target task can be costly, as it may entail extensive annotation of the quality of outputs of different AI models. The illustrative embodiments introduce an efficient method, computer program product, and computing tool to make an informed decision between candidate AI computer models based on preference annotations. The mechanisms of the illustrative embodiments reduce the required amount of annotations, thus saving valuable time and resources in performing AI model evaluation. The minimal annotation AI model selection engine of the illustrative embodiments intelligently select instances by clustering embeddings that represent the semantic differences between AI model outputs. Thus, the minimal annotation AI model selection engine is able to identify a subset of examples that are more informative for AI model preference decisions. It has been determined that the minimal annotation AI model selection engine of the illustrative embodiments can dramatically reduce the required number of annotations by up to approximately 75% while maintaining high AI model evaluation reliability.

As shown in FIG. 2, the minimal annotation AI model selection engine 200 comprises AI model provider interfaces 210, test set engine 220, AI model output embedding engine 230, difference vector generator 240, clustering engine 250, and representative example selection and annotation engine 260. The minimal annotation AI model selection engine 200 further includes annotated example storage 270 for use by an AI model selection engine 280. The minimal annotation AI model selection engine 200 may operate in conjunction with one or more AI model providers 292-296 via one or more data networks 290. For example, the AI model selection engine 280 may operate in response to a request from a requestor computing device 298 for an AI model selection for a given task. The AI model selection engine 280 may utilize the selected representative test cases and their annotations for performing such selection. For example, as further described herein, each selected representative test case example corresponds to a pair of outputs—y_{A} from AI model A and y_{B} from AI model B. The content of the annotation indicates a quality preference between the models A and B of the pairing (A>B, A<B, or A=B). An AI model may be selected in some illustrative embodiments by counting the annotations, e.g., if there are more pairs that have A>B than B>A, model A may be selected, and vice versa. While shown as a separate entity from the minimal annotation AI model selection engine 200, the minimal annotation AI model selection engine 200 may in some illustrative embodiments be integrated with the AI model selection engine 280 to perform operations to select an AI model for use in performing a specified task.

The minimal annotation AI model selection engine 200 operates to minimize the number of annotated examples needed to perform AI model selection. The illustrative embodiments will be described with regard to text generation AI models, such as generative AI computer models for generating natural language text, but should not be considered to be limited to such. Rather, the illustrative embodiments may be utilized with any AI computer model selection, whether for text generation or any other AI computer model based task, without departing from the spirit and scope of the present invention.

Before discussing the individual elements of the minimal annotation AI model selection engine 200 in detail, it is beneficial to first have an outline of the particular problem addressed and the solution implemented by the minimal annotation AI model selection engine 200. The problem of AI model selection may be defined as follows. Given a pair of text generation AI computer models 292 and 294, it is desired to evaluate which AI computer model 292, 294 is stronger with regard to a given text generation task, based on preference labels of an oracle over the AI model outputs. For an input instance x and a pair of AI computer models M_{A}, M_{B} with corresponding outputs y_{A}, y_{B}, a preference label y_{pref} ∈{M_{A}, M_{B}, T} indicates whether y_{A} is better than y_{B} (M_{A}), worse than y_{B} (M_{B}), or similar to y_{B} (T), where T is a “tie” (y_{A}=y_{B}). The AI model for which the outputs over a test set Dₜₑₛₜ are more frequently preferred may be defined formally as:

$${W}_{test} = {M}_{A} if {P}_{test}^{{M}_{A}} > {P}_{test}^{{M}_{B}} ;$$

$${W}_{test} = {M}_{B} if {P}_{test}^{{M}_{A}} < {P}_{test}^{{M}_{B}} ; and$$

$${W}_{test} = T if {P}_{test}^{{M}_{A}} = {P}_{test}^{{M}_{B}} , where$$

$${P}_{test}^{m} = \frac{1}{\vert {D}_{test} \vert} {\sum }_{( x , {y}_{pref} ) ∈ {D}_{test}} {𝕀}_{\{ {y}_{pref} = m \}} .$$

$${P}_{test}^{m}$$

is the test winning probability of model m∈{M_{A}, M_{B}}, and Π_{{y}_{_{pref}}_{=m}} is the indicator function that takes the value 1 if y_{pref}=m and 0 otherwise. The absolute difference between the test winning probabilities of the two models is

$$\vert {P}_{test}^{{M}_{A}} - {P}_{test}^{{M}_{B}} \vert .$$

Calculating the test winning model requires preference labels for every point in the test set. However, this often is costly and impractical. Thus, the goal is to maximize the probability of identifying the test winning model under a given annotation budget N by intelligently selecting only a subset of examples

$${D}_{test}^{observed} ⊆ {D}_{test}$$

from the test set to be annotated (labeled) by the oracle. The oracle is the component that looks at pairs of y_{A}, y_{B} and gives the preference labels y_{pref} of which model in the pair is determined to provide a better performance. The oracle can be an AI computer model that generates the annotation specifying the preference of one model over the other. The model selection, as noted above, in some illustrative embodiments, is determined based on the number of preference labels that the oracle generates for each model.

The minimal annotation AI model selection engine 200 relies on the outputs generated by the AI models by representing examples in a manner that captures the distribution of model mismatching behaviors, i.e., various types of differences between model outputs. To this end, AI model outputs are embedded into a semantic vector space. Any type of suitable embedding may be utilized without departing from the spirit and scope of the present invention. For example, in some illustrative embodiments, a sentence or word BERT (Bidirectional Encoder Representations from Transformers) encoder may be used to embed the outputs. Subsequently, difference vectors are generated by subtracting the embeddings of one AI model from the embeddings of the other AI model in a pairing of AI models, for each example in the test set.

These difference vectors are clustered to select one representative difference vector from each cluster to be annotated (or labeled) by the oracle. The particular clustering algorithm may take different forms depending on the desired implementation. In some illustrative embodiments, a hierarchical agglomerative clustering algorithm may be used. However, other clustering algorithms may be used without departing from the spirit and scope of the present invention.

The particular representative difference vector selected from each cluster may be selected according to any desired selection criterion for the particular implementation. In some illustrative embodiments, the representative difference vector selected from a cluster may be one whose embedding is closest, to the center of the cluster, which may be measured by a distance metric, such as cosine distance, for example. The number of clusters may be selected to correspond with a given annotation budget N, e.g., for a budget of N, N or fewer clusters may be generated such that the number of selected examples will also be N or fewer.

The difference vector can be correlated with the particular example from the test set that generated that difference vector and thus, the selection of a representative difference vector may be mapped to the example to be annotated. The particular annotation may be performed automatically by labeling the example with the preference for the better performing AI model. Given the construction of the difference vectors, the vector space will carry information about semantic differences, i.e., the nature of disagreements between AI models. Choosing an example from each cluster ensures that the set of selected examples is representative of this vector space. Thus, these selected examples are informative for estimating which AI model is the preferred AI model for a given task. Once the examples are selected, the oracle looks at the selected examples, e.g., at the corresponding textual outputs from the two AI models and for each one, makes a preference annotation. Then, as mentioned above, the AI model selection is performed by the AI model selection engine 280 based on a counting of the preference annotations and selecting the AI model having the greatest number of preference annotations.

With reference again to the specific elements of FIG. 2, in view of the outline of the problem and solution above, in order to select examples of a test set for selection of an AI model for a given task, pairings of AI models 292-296 are identified and accessed via the AI model provider interfaces 210. For N number of AI models 292-296, each pairing of AI models may be selected and evaluated such that based on the pairings, test examples are annotated (labeled) with preference information specifying which AI models are preferred for the example. The labels are preference decisions for each pair of outputs as to which output is better, e.g., y_{A}>y_{B} Or y_{A}<y_{B} or y_{A}=y_{B}. In some illustrative embodiments, the AI models 292-296 are provided by one or more AI model providers and are accessible through one or more well defined interfaces, application programming interfaces (APIs), or the like, which may be implemented in the AI model provider interfaces 210.

The test set engine 220 may provide examples of a test set to the pairings of AI models 292-296 to obtain AI model outputs. That is, each test set example is provided to both AI models 292, 294 (AI model pairing 294, 296, and AI model pairing 292, 296, as well). In each pairing, and for each test set input example, outputs are generated by the AI models of the pairing. The outputs are provided to the AI model output embedding engine 230 which generates an embedding of the outputs to thereby provide embedding vectors. Thus, between two AI computer models of a given pairing, e.g., 292, 294, the AI computer models perform inferences on all examples using both AI computer models and then embed each output using a third AI computer model, i.e., the AI model output embedding engine 230. For example, if the two AI computer models 292, 294 are AI models that generate text output, the third AI computer model, i.e., the AI model output embedding engine 230, may be an encoder language model (LM) that embeds the output.

The embeddings are input to the difference vector generator 240 which generates a difference vector for the particular pairing and the particular test case example. The difference vector is generated by computing a point-wise difference between the embeddings of the two AI computer model outputs. This may be performed for each test example in the test set such that a plurality of difference vectors are generated and are associated with the corresponding test example that was used to generate the AI computer model outputs and difference vectors. The plurality of difference vectors may be input to the clustering engine 250 which clusters the difference vectors based on similarity. The number of clusters generated may be based on the number of examples to be included in the final set of annotated examples, e.g., if there are to be N examples in the final annotated set of examples, then N clusters may be generated during the clustering of the difference vectors.

Based on the clusters of difference vectors, the representative example selection and annotation engine 260 selects a representative difference vector from each cluster. The representative difference vector may be selected according to any desirable criteria, but in an example illustrative embodiment is a difference vector that is closest to the center of the cluster. The selected difference vectors are then correlated with their corresponding test examples, which are selected for annotation. The selected test examples are annotated with preference information for AI models, and the test examples are stored in an annotated test example storage for use in performing AI model selection for the given task by the oracle. The annotated examples are counted to generate counts for instances where the oracle annotation is A>B and where the annotation is A<B. The AI model with the greater number of “wins” is selected as the best performing AI model.

Thus, with the mechanisms of the illustrative embodiments, the AI model selection engine 280 selects particular AI computer model for a given task based on the preference annotations of a relatively small number of test examples. That is, the AI computer models in each pairing perform the given task using the test examples to generate the embedding vectors, e.g., the task may be specified in a prompt to the AI computer models with the test examples being the context of the prompt. The differences between the vector embeddings of the various pairings of AI computer models are then used to generate the minimized number of test examples that need to be annotated with AI model preference annotations. These test examples are then used to select the best performing AI model for the given task, such as by determining the counts for each AI computer model in the preference annotations. Thus, a minimized set of test examples are annotated with AI computer model preference information to permit selection of best performing AI computer models for given tasks.

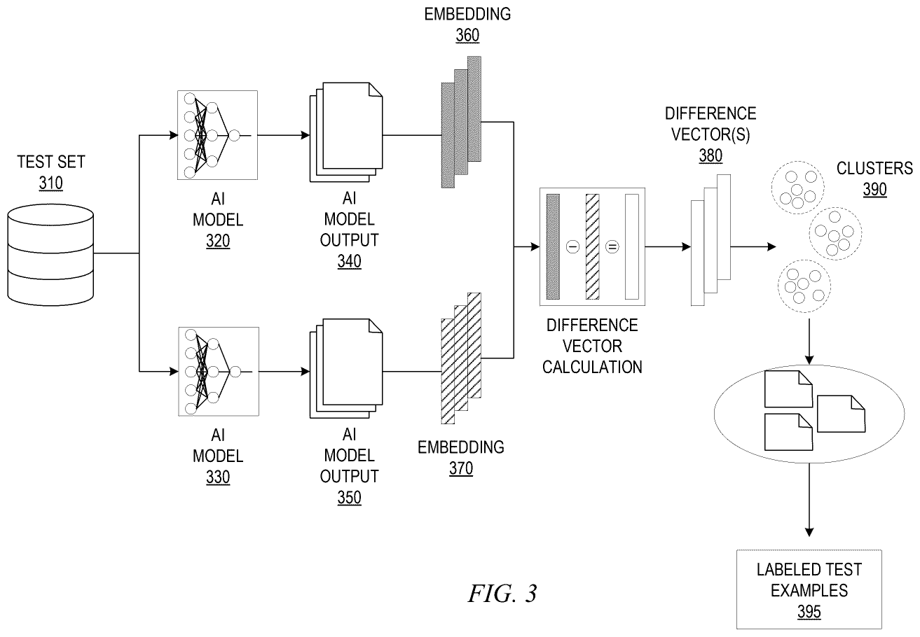

FIG. 3 is an example block diagram illustrating an operational flow of the minimal annotation AI model selection engine in accordance with one illustrative embodiment. As shown in FIG. 3, the test set 310 is input to the pair of AI computer models 320, 330, i.e., models A and B in this example. The AI models A and B generate their own respective AI model outputs 340, 350, i.e., outputs A and B, for each test example in the test set. The outputs 340, 350 from the AI models are the basis for the generation of AI model output embeddings A and B 360, 370. A difference between these embeddings is calculated to generate a difference vector 380. The difference vector 380 is clustered into a plurality of clusters 390. Thereafter, representative difference vectors are selected from each cluster and annotated (labeled) to generate labeled test examples 395, which are a subset of the test examples in the test set and which are annotated by the oracle with labels that can be used to select an AI computer model for a given task.

It should be appreciated that the accuracy in estimating the “winning” AI computer model, i.e., the AI computer model that should be selected for performing a given task, may vary depending on the budget size, i.e., the number N of clusters, as well as the actual performance gap between the AI computer models. In real-world scenarios, users do not know in advance the size of the performance gap between the AI computer model. Moreover, after annotating test examples with an oracle an estimating a winning AI computer model, users will not know whether the estimation or selection is in fact correct.

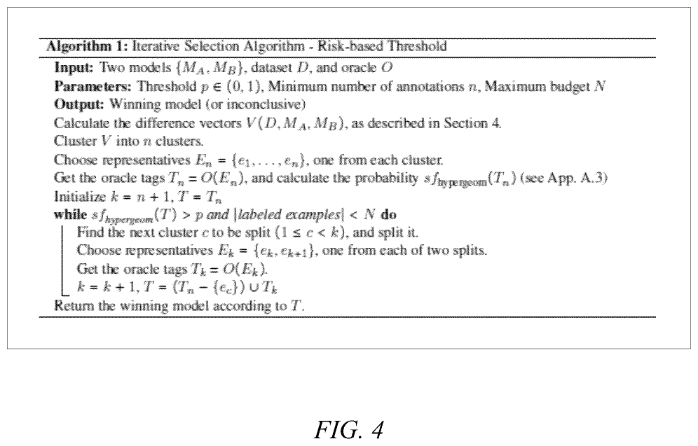

Thus, in order to reduce oracle effort in practice, an approach is used to determine the minimal budget required and provides an approximation of the reliability of the winning model selection. To this end, an iterative method for selecting test examples for annotation may be utilized. In this iterative approach, the number of test examples processed via the oracle of the illustrative embodiments is gradually increased until a predetermined reliability threshold is met. An algorithm for implementing this iterative approach is shown in FIG. 4.

For example, assume that the difference vectors of the AI computer model pairings are clustered into k clusters and k test examples are selected, in accordance with one or more of the illustrative embodiments described above. In a subsequent iteration, k+1 clusters may be utilized which further partitions one of the previous clusters, providing two new selected examples to be annotated by the oracle of the illustrative embodiments. With each partitioning step, the amount of information increases and the procedure is repeated until reaching the reliability threshold. In some illustrative embodiments, the reliability threshold may be based on a hypergeometric distribution. The reliability threshold is a heuristic that approximates the level of risk, where a threshold of 0.1, for example, loosely corresponds to a likelihood of up to 10% of incorrectly selecting an AI computer model. The threshold is predetermined and reflects a preferred point on a trade-off between the user's tolerance for error and the amount of test examples the oracle will need to annotate.

As shown in FIG. 4, the iterative algorithm may be used to increase the number of clusters, and thus, the number of selected test examples for annotation, until a reliability threshold is met. This reliability oriented stopping criterion, as noted above, may be based on a hypergeometric distribution in some illustrative embodiments. This distribution describes the probability of a “success” when sampling without replacement, and is parameterized by a population size N, sample size n, number of successes in the population K and number of successes in the sample k.

Specifically, the hypergeometric distribution is considered a survival function, sf_{hypergeom}(k−1), which describes the probability of getting k or more successes by chance. In an AI computer model comparison scenario, such as the illustrative embodiments, n corresponds to the number of text examples annotated by the oracle, and k to the number of votes received by the winning AI computer model within the test set. A null hypothesis is defined as one where the winning AI computer model is the winner in 50% of the instances in the full test set, i.e., where K=N/2. Using this value for K, the result sf(k−1) thus reflects how likely or unlikely it is to get a value of k or higher given a ground-truth 50% win rate.

For example, assume that test examples are selected out of a full test set of 500 unlabeled test examples. The oracle of the illustrative embodiments is given a total of 10 test examples to label, and determines that model A was the winner in 8 of them: sf(k−1, N, K, n)=sf(7, 500, 250, 10)=0.0529. Thus, in this example, given the null hypothesis and assuming a hypergeometric distribution, there is only a ≈5% probability of getting such a high win rate (or a higher one) by chance. In other words, a situation where model A is the winner in just 50% of the full test set, and an 8/10 result was obtained, is relatively unlikely. A situation where model A is the winner in under 50% of the test set is even less likely. This means that the user can be fairly confident that the correct winner AI computer model was chosen.

Thus, when applying the iterative algorithm, such as shown in FIG. 4 for example, the user sets an acceptable risk level, e.g., 10%, in advance and at each iteration, the survival function (sf) is calculated using the current values of n and k. If the value of sf is lower than the risk level (e.g., 10%), the result is considered sufficiently reliable. If the value of sf is not lower than the risk level, the sample size n is increased and additional test examples are selected and annotated (labeled) by the oracle of the illustrative embodiments.

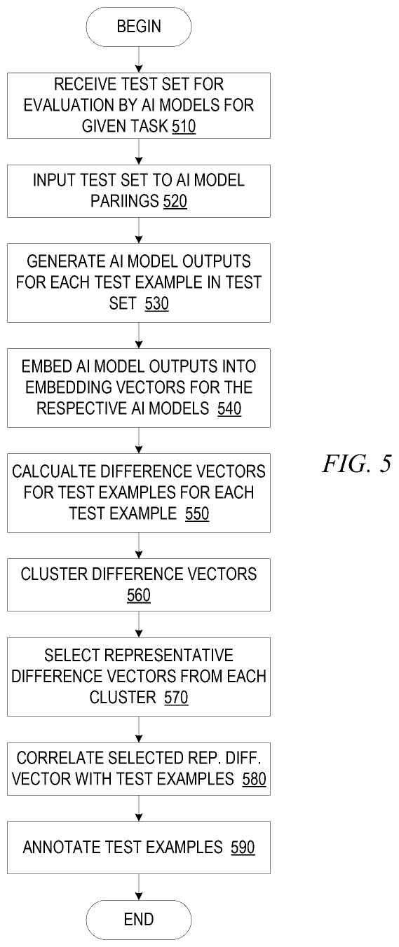

FIG. 5 is a flowchart outlining an example operation of a minimal annotation AI model selection engine in accordance with one illustrative embodiment. It should be appreciated that the operations outlined in FIG. 5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 5, and may, in some cases, make use of the results generated as a consequence of the operations set forth in FIG. 5, the operations in FIG. 5 themselves are specifically performed by the improved computing tool in an automated manner.

As shown in FIG. 5, the operation starts with the input of a test set for evaluation of AI models for a given task (step 510). The test set is input to a pair of AI computer models (step 520) which generate AI model outputs for each test example in the test set (step 530). The AI model outputs are embedded to generate AI model output embedding vectors for the respective AI models (step 540). A difference between the embedding vectors is calculated to thereby generate a difference vector for each test example (step 550). The calculated difference vectors for the test examples of the test set are clustered into clusters (step 560). A representative difference vector is selected from each cluster (step 570). The selected difference vectors are correlated with their respective test example (step 580). The corresponding test examples are then annotated by an oracle with AI model preference information and stored in an annotated test example set for use in selecting an AI model for a given task (step 590). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
processing, by a first artificial intelligence (AI) computer model, each test example of a test set to generate a corresponding first AI computer model output;
processing, by a second AI computer model, each test example of the test set to generate a corresponding second AI computer model output;
generating a first vector embedding of the first AI computer model output and a second vector embedding of the second AI computer model output;
generating a difference vector based on a difference between the first vector embedding and the second vector embedding;
clustering the difference vectors into a plurality of clusters of difference vectors for test examples of the test set;
selecting, from each cluster in the plurality of clusters, a representative difference vector to generate a plurality of selected representative difference vectors; and
for each selected representative difference vector in the plurality of selected representative different vectors, annotating a test example corresponding to the selected representative difference vector with an AI model preference annotation to thereby generate an annotated test example set.

2. The method of claim 1, further comprising receiving a request for selection of an AI computer model to perform an input task, wherein the first AI computer model and second AI computer model perform the input task on the test examples of the test example set.

3. The method of claim 1, wherein the first vector embedding and second vector embedding are text embeddings in a semantic vectors space generated by a bidirectional encoder representation from transformers (BERT) encoder.

4. The method of claim 1, wherein the clustering is generated by processing the difference vectors with a hierarchical agglomerative clustering algorithm.

5. The method of claim 1, wherein a number of clusters in the plurality of clusters is equal to a predetermined budget value N, and wherein the budget value is incrementally increased in response to a reliability evaluation in accordance with an iterative algorithm.

6. The method of claim 5, wherein the reliability evaluation calculates a survival function value at each iteration and compares the survival function value to a predetermined risk level value, and wherein the incremental increases in the budget value are continued for each iteration until the survival function value is determined to be lower than the risk level value.

7. The method of claim 1, wherein, for each cluster in the plurality of clusters, selecting a representative difference vector comprises selecting a difference vector in the cluster that is closest to a center of the cluster.

8. The method of claim 1, wherein the method is executed by an oracle computing system that operates to automatically select an AI computer model to perform an input task based on the annotated test example set.

9. The method of claim 8, wherein the oracle computing system is a large language model (LLM).

10. The method of claim 1, wherein the first AI computer model is one of a plurality of first AI computer models and the second AI computer model is one of a plurality of second AI computer models, and wherein the method is executed for each pairing of a first AI computer model in the plurality of first AI computer models, and a second AI computer model in the plurality of second AI computer models.

11. A computer program product comprising:
one or more computer-readable storage media; and
program instructions stored on the one or more computer-readable storage media to perform operations comprising:
processing, by a first artificial intelligence (AI) computer model, each test example of a test set to generate a corresponding first AI computer model output;
processing, by a second AI computer model, each test example of the test set to generate a corresponding second AI computer model output;
generating a first vector embedding of the first AI computer model output and a second vector embedding of the second AI computer model output;
generating a difference vector based on a difference between the first vector embedding and the second vector embedding;
clustering the difference vectors into a plurality of clusters of difference vectors for test examples of the test set;
selecting, from each cluster in the plurality of clusters, a representative difference vector to generate a plurality of selected representative difference vectors; and
for each selected representative difference vector in the plurality of selected representative different vectors, annotating a test example corresponding to the selected representative difference vector with an AI model preference annotation to thereby generate an annotated test example set.

12. The computer program product of claim 11, further comprising receiving a request for selection of an AI computer model to perform an input task, wherein the first AI computer model and second AI computer model perform the input task on the test examples of the test example set.

13. The computer program product of claim 11, wherein the first vector embedding and second vector embedding are text embeddings in a semantic vectors space generated by a bidirectional encoder representation from transformers (BERT) encoder.

14. The computer program product of claim 11, wherein the clustering is generated by processing the difference vectors with a hierarchical agglomerative clustering algorithm.

15. The computer program product of claim 11, wherein a number of clusters in the plurality of clusters is equal to a predetermined budget value N, and wherein the budget value is incrementally increased in response to a reliability evaluation in accordance with an iterative algorithm.

16. The computer program product of claim 15, wherein the reliability evaluation calculates a survival function value at each iteration and compares the survival function value to a predetermined risk level value, and wherein the incremental increases in the budget value are continued for each iteration until the survival function value is determined to be lower than the risk level value.

17. The computer program product of claim 11, wherein, for each cluster in the plurality of clusters, selecting a representative difference vector comprises selecting a difference vector in the cluster that is closest to a center of the cluster.

18. The computer program product of claim 11, wherein the method is executed by an oracle computing system that operates to automatically select an AI computer model to perform an input task based on the annotated test example set.

19. The computer program product of claim 18, wherein the oracle computing system is a large language model (LLM).

20. A computer system comprising:
a processor set;
one or more computer-readable storage media; and
program instructions stored on the one or more computer-readable storage media to cause the processor set to perform operations comprising:
processing, by a first artificial intelligence (AI) computer model, each test example of a test set to generate a corresponding first AI computer model output;
processing, by a second AI computer model, each test example of the test set to generate a corresponding second AI computer model output;
generating a first vector embedding of the first AI computer model output and a second vector embedding of the second AI computer model output;
generating a difference vector based on a difference between the first vector embedding and the second vector embedding;
clustering the difference vectors into a plurality of clusters of difference vectors for test examples of the test set;
selecting, from each cluster in the plurality of clusters, a representative difference vector to generate a plurality of selected representative difference vectors; and
for each selected representative difference vector in the plurality of selected representative different vectors, annotating a test example corresponding to the selected representative difference vector with an AI model preference annotation to thereby generate an annotated test example set.
